(19) United States
(12) Patent Application Publication
(10) Pub. No.: US 2007/0168203 A1
(43) Pub. Date: Jul. 19, 2007

(54) Context-based mapping of a content repository in a context driven component execution environment

(75) Inventors: Victor Chan, Thornhill (CA); Mark W. Hubbard, Maple (CA); Jacob Vandergoot, Bradford (CA); Tony C. Woo, Newmarket (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/333,162

(22) Filed: Jan. 17, 2006

(51) Int. Cl. G06Q 99/00; G07G 1/00

(52) U.S. Cl. 705/1; 705/10

(57) ABSTRACT

Embodiments of the present invention provide a method, system and computer program product for a content repository mapping method. In one embodiment, the method can include obtaining a context to a transaction and selecting a content repository from among a set of content repositories based upon the obtained context. Each of the content repositories can conform to a uniform data structure, but can have differing values for selected fields of the data structure. As such, the method can include mapping the selected content repository for data access during the transaction. For example, mapping the selected content repository for data access during the transaction can include setting the selected content repository as a data source for data access logic in the application.

### BACKGROUND OF THE INVENTION

1. Field of the Invention

The present invention relates to the field of commerce computing and more particularly to context driven component based commerce systems.

2. Description of the Related Art

As businesses and consumers become further interconnected through computer communications networks such as the global Internet and local intranets, the commerce sites and companion computing applications which integrate interactions between businesses and consumers alike can become ever more complex. Addressing the explosion of business to business and business to consumer interactions on-line, information technologists increasingly focus on architecting and implementing complete commerce site solutions to reflect the entire life cycle of a business in lieu of integrating multiple, disparate applications which when combined reflect the business life cycle. Consequently, as modern commerce sites can be both large and distributed, commerce systems have been configured to deploy complete e-commerce systems in as seamless a fashion as possible.

It is now a common trend that traditional, stand-alone, commerce oriented applications are produced from one or more components which can be individually re-used to create business processes for different solutions. Each of these components can expose itself as a set of services comporting with computing standards for deploying enterprise level logic that facilitate an open service oriented architecture (SOA). An SOA essentially can be defined as a collection of services. These services communicate with each other, which communication can involve either simple data passing between two or more services, activity coordinating by two or more services.

In an SOA, a client can invoke a service within a component to perform an operation and, optionally the client can receive a response. Invoked services generally can include business services configured to fulfill the needs of business customers, whether those customers are individual consumers or other businesses. The services can be grouped into various SOA components where each component can specialize in functions such as catalog management, shopping cart management, credit card transaction processing, sales tax computation and the like.

Within a commerce model, stateless transactions can be combined to form an activity in the aggregate. The context of the activity can be maintained centrally by the commands forming the basis of the commerce system implementing the commerce model. The context can include aspects of an activity such as the parties to the activity, the resources supporting the completion of the activity, and the medium of the activity. For example, contextual data can include a customer classification, a store identifier, a common language identifier, or a currency type.

Given the varying potential contexts for a transaction in an SOA component, different SOA components must be written to accommodate the different potential contexts. The different SOA components can vary for different contexts according to logic performed and data accessed. In regard to the latter, values for content in a content repository can vary from context to context, while the data structure for the values can remain constant. For example, pricing values for goods and services in a content repository can vary according to customer classification though the data structure for the different content repositories can remain the same. Specifically, some customers are entitled to lower prices for the same good or service than other customers.

Though unwieldy and inefficient, at present a singly purposed SOA component must be developed separately to map to a specific content repository depending upon the context of a corresponding transaction. In particular, each different implementation of a singly purposed SOA component can map to a specific repository according to a specific context. A particular implementation of the SOA component can be selected for use depending upon the context of the transaction. Yet, changes to the singly purposed SOA component must be propagated across all implementations of the singly purposed SOA component for all contexts to maintain consistency for the singly purposed SOA component.

### BRIEF SUMMARY OF THE INVENTION

Embodiments of the present invention address deficiencies of the art in respect to data access in a component based application and provide a novel and non-obvious method, system and apparatus for content repository mapping based upon context. In one embodiment, a component based data processing system can be provided. The component based data processing system can have an SOA and can include content repositories, each of the content repositories conforming to a uniform data structure, but having different values for fields of the data structure. The system also can include a runtime environment coupled to a business context service and a component based application supported by the runtime environment. In one aspect of the invention, the business context service can be disposed in a business context engine.

The component based application can include at least one component including both business logic and also data access logic. For instance, the business logic can include a controller command coupled to at least one task command. Importantly, the system can include repository mapping logic coupled to the component based application and business context service. The repository mapping logic can include program code enabled to map one of the content repositories to the data access logic based upon a context for a transaction received from the business context service.

In another embodiment of the invention, a content repository mapping method can be provided. The method can include obtaining a context to a transaction and selecting a content repository from among a set of content repositories based upon the obtained context. In one aspect of the invention, obtaining a context to a transaction can include retrieving a context for a transaction from a business context service in a business context engine managing the transaction. In another aspect of the invention, selecting the content repository can include matching the obtained context to a particular content repository in an application, and selecting the particular content repository for use when accessing data from the application for the transaction.

Each of the content repositories can conform to a uniform data structure, but can have differing values for selected fields of the data structure. As such, the method can include mapping the selected content repository for data access during the transaction. For example, mapping the selected content repository for data access during the transaction can include setting the selected content repository as a data source for data access logic in the application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a commerce system configured to manage business context services for adaptable SOA components;

FIG. 2 is a block diagram illustrating a process for utilizing the business context services of the commerce system of FIG. 1;

FIG. 3 is a block diagram of the commerce system of FIG. 1 configured for context based content repository mapping; and,

FIG. 4 is a flow chart illustrating a process for context based content repository mapping.

### DETAILED DESCRIPTION OF THE INVENTION

Embodiments of the present invention provide a method, system and computer program product for context based mapping of a content repository. In accordance with an embodiment of the present invention, multiple different repositories can be established for a common data structure. The common data structure can include a set of specified data fields, however, each different repository can provide different values for the specified data fields. During a transaction, the context of the transaction can be obtained and utilized to select a particular one of the different repositories for mapping to the business logic for the transaction. Subsequently, the selected repository can be accessed in the course of the transaction.

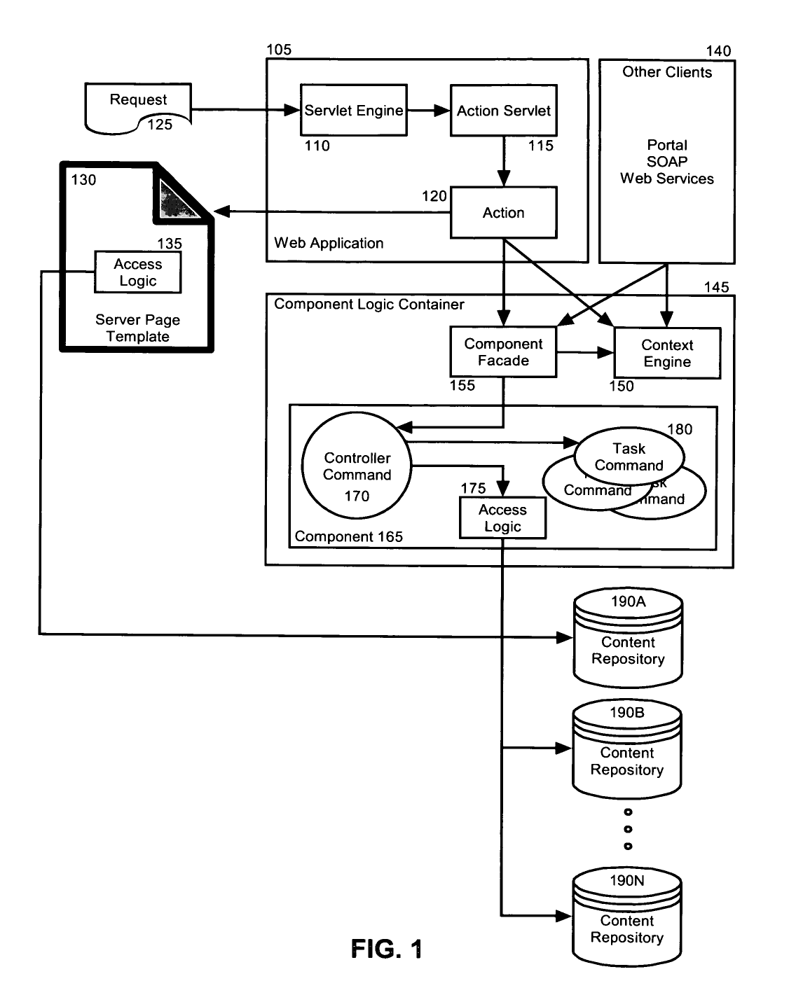

Notably, the context based mapping of the content repository can support a context sensitive commerce system providing business context services through adaptable SOA components. In illustration, FIG. 1 is schematically depicts an exemplary albeit non-exclusive commerce system configured to manage business context services for adaptable SOA components. The commerce system can include one or more service invoking client platforms including a Web application 105, as well as other clients 140 such as a portal client, simple object access protocol (SOAP) client, and a Web services client to name a few. For purposes of illustrative efficiency, only a Web application 105 is shown in detail.

The Web application 105 can be communicatively coupled to a component logic container 145 which in turn can be communicatively coupled to persistent storage 190. The Web application 105 can host a servlet engine 110 which can process requests 125 for commerce services through an action servlet 115. The action servlet 115, in turn, can be configured to invoke actions 120 logically linked both to a commerce application view 130 and also to a component facade 155 programmed to invoke business logic within one or more components 165 disposed with the component logic container 145.

For instance, the component facade 155 can be a component stateless session bean (SSB) logically coupled to one or more components 165 which when combined form a commerce system solution. Each of the components 165 can include a controller command 170 having one or more task commands 180. The controller command 170 further can be logically linked to access logic 175 configured to access persisted data in a mapped one of a set of content repositories 190A, 190B, 190N which conform to a common data structure. Similarly, the commerce application view 130 can include access logic 135 likewise configured to access persisted data in the mapped one of a set of content repositories 190A, 190B, 190N.

Notably, the component facade 155 can be coupled to a business context engine 150. The business context engine 150 can manage an activity, where the activity can include a series of consecutive requests 125 from one or more service clients, in order to treat the consecutive series of requests 125 as a single conversation as between the service clients and the commerce system service defined by the components 165. The context engine 150 is responsible for managing the business contexts associated with an activity.

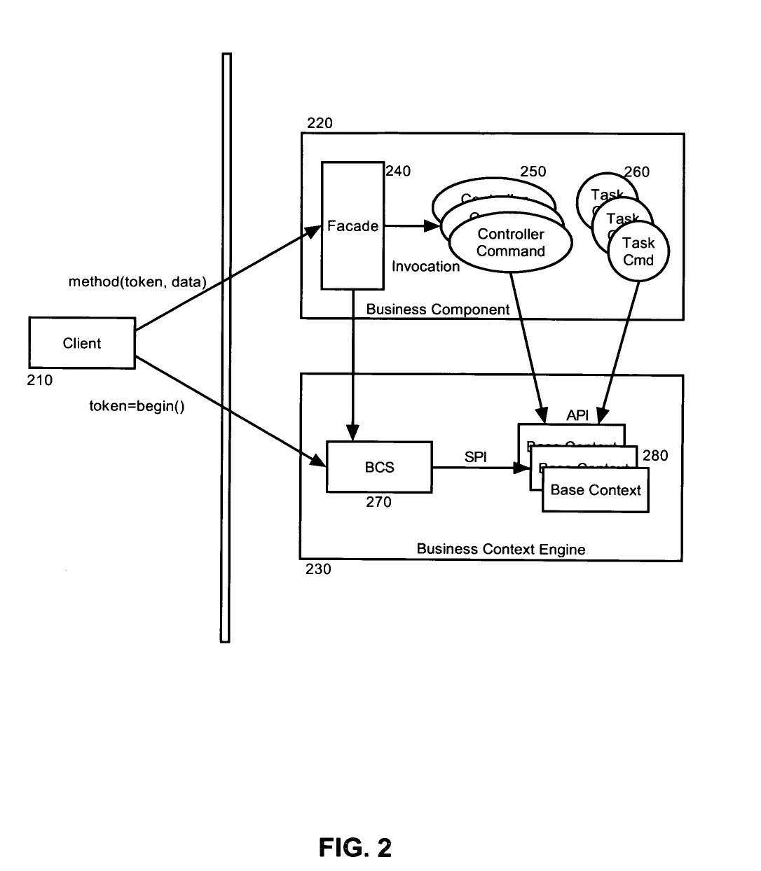

As it will be apparent from the schematic illustration of FIG. 1, the SOA of FIG. 1 can be divided into two main parts: the context engine and the component service. The context engine provides context related services while the component service provides a facade to the commands and facilities to instantiate and execute a command in the commerce system. In more particular illustration, FIG. 2 is a block diagram illustrating a process for utilizing the business context services of the commerce system of FIG. 1 in the course of executing the business logic of a system component.

As shown in FIG. 2, a client computing process 210 can establish a communicative linkage to a business component 220 in addition to a business context engine 230. The business component 220 can include a component facade 240 through which business logic in the form of controller commands 250 and underlying task commands 260 can be invoked. The business context engine 230, in turn, can include a business context service 270 coupled to one or more business contexts 280.

In operation, the client computing process 210 can obtain an activity token from the business context engine 230 which can include a specific set of business contexts. The client computing process 210 subsequently can pass the activity token to the business component 220 in the course of a business task in order to provide contextual information for completing the task. For instance, the business component 220 further can access elements of the business contexts 280 by way of an application programming interface (API) to the business context engine 230 utilizing the specific information of the activity token.

Specifically, to invoke a method on a business component, a client 210 or component facade 240 can obtain an activity token by first making a call to the interface of the business context service 270. In the process of obtaining the activity token, the client 210 or component facade 240 optionally can supply initialization data that can be used to populate pre-loaded contexts during creation of a new activity. Subsequently, the client 210 can pass the activity token to the component facade 240 when a particular method is invoked on the interface to the business component 220.

Notably, the activity token can be used to associate a set of contexts in effect during particular client requests to the various business components. The client can supply the activity token on every request to indicate the experience that the client would like from the business components. These contexts can include, by way of example, a solutions context indicating whether a requested operation in an activity is to be performed by a specified entity, or through an entity which acts on behalf of a specified entity. The contexts also can include a globalization context providing globalization information, an entitlement context providing information for promotional entitlement programs, a content context providing versioning information for specified content, a task context indicating a current task or state for a process having multiple tasks, and an audit context providing auditing information, to name only a few contexts.

Advantageously, unlike conventional commerce system implementations in which the context of an activity is maintained centrally in a command context, in the present invention, the context of a business task can be maintained across one or more business contexts which can be incorporated into or referenced by activity tokens passed between the different business components when processing the task. Consequently, the state of each business context can be maintained across requests and transactions so that a significant performance improvement can be realized.

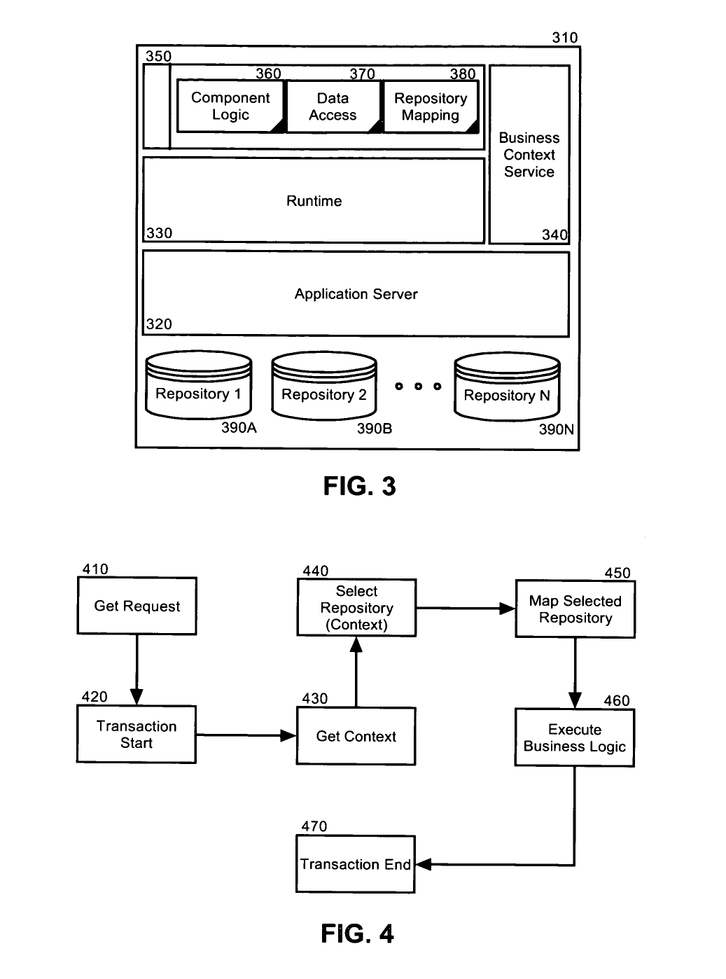

Importantly, the business contexts 280 can be utilized in mapping a content repository to component logic within the business component 220 for use during a transaction. In further illustration, FIG. 3 is a block diagram of a host platform configured for context based content repository mapping for business context services. As shown in FIG. 3, a computing platform 310 can host an application server 320 and a multiplicity of content repositories 390A, 390B, 390N, each conforming to a uniform data structure, albeit each containing disparate values for fields in the uniform data structure.

The application server 320 can support the execution of a commerce system runtime environment 330 providing core functions for supporting a commerce system. The runtime environment 330 can support a specific, component-based application 350 which can include component logic 360, data access logic 370 and repository mapping logic 380. The component logic 360 can provide the business logic for the application 350, while the data access logic 370 can provide the logic instructions for retrieving data from a mapped one of the content repositories 390A, 390B, 390N. Finally, the repository mapping logic 380 can include program code enabled to map the data access logic 370 to a particular one of the content repositories 390A, 390B, 390N dependent upon a business context for a transaction provided through the runtime environment 330 by a coupled business context service 340. Optionally, the repository mapping logic 380 can be separate from the runtime environment 330 and the data access logic 370, or the repository 380 can be disposed within either the runtime environment 330 or the data access logic 370.

In more particular illustration, FIG. 4 is a flow chart illustrating a process for mapping a content repository to access logic for a transaction based upon a business context for the transaction. Beginning in block 410, a request can be received to initiate a transaction in a component of a component based application. In block 420, the transaction can begin and in block 430, a context for the transaction can be obtained. In this regard, the context of the transaction can include, by way of example only, the classification of the requestor or the environment of the transaction such as the time of day, day of week, or month of year.

In block 440, a content repository conforming to a uniform data structure can be selected from among several content repositories which each conform to the uniform data structure. In particular, the selection can be based upon the context of the transaction. Subsequently, in block 450, the selected content repository can be mapped to data access logic for the transaction. As such, in block 460, business logic for the transaction can transpire with content requests and updates occurring through the data access logic utilizing the mapped content repository. Finally, when the business logic operations have completed, in block 470 the transaction can end.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A component based data processing system comprising:
a plurality of content repositories, each of the content repositories conforming to a uniform data structure, but having different values for fields of the data structure;
a business context service;
a runtime environment configured for coupling to the business context service;
a component based application supported by the runtime environment, the component based application comprising at least one component comprising business logic and data access logic; and,
repository mapping logic coupled to the component based application and business context service, the repository mapping logic comprising program code enabled to map at least one of the content repositories to the data access logic-based upon a context for a transaction received from the business context service.

2. The component based data processing system of claim 1, wherein the component based data processing system has a service oriented architecture (SOA).

3. The component based data processing system of claim 1, wherein the business context service is disposed in a business context engine.

4. The commerce system of claim 1, wherein the business logic of the at least one component comprises a controller command coupled to at least one task command.

5. The commerce system of claim 1, wherein the repository mapping logic coupled to the component based application and business context service is disposed within the runtime environment.

6. The commerce system of claim 1, wherein the repository mapping logic coupled to the component based application and business context service is disposed within the data access logic.

7. The commerce system of claim 1, wherein both the repository mapping logic coupled to the component based application, and also the business context service are separate from both the runtime environment and also the data access logic.

8. A content repository mapping method comprising:
obtaining a context to a transaction;
selecting at least one content repository from among a set of content repositories based upon the obtained context, each of the content repositories conforming to a uniform data structure, but having differing values for selected fields of the data structure; and,
mapping the at least one selected content repository for data access during the transaction.

9. The method of claim 8, wherein obtaining a context to a transaction, comprises retrieving a context for a transaction from a business context service in a business context engine managing the transaction.

10. The method of claim 8, wherein selecting at least one content repository, comprises:
matching the obtained context to at least one particular content repository in an application; and,
selecting the at least one particular content repository for use when accessing data from the application for the transaction.

11. The method of claim 8, wherein mapping the at least one selected content repository for data access during the transaction, comprises setting the at least one selected content repository as a data source for data access logic in the application.

12. A computer program product comprising a computer usable medium having computer usable program code for content repository mapping embodied therein, the computer program usable program code comprising:
computer usable program code for obtaining a context to a transaction;
computer usable program code for selecting at least one content repository from among a set of content repositories based upon the obtained context, each of the content repositories conforming to a uniform data structure, but having differing values for selected fields of the data structure; and,
computer usable program code for mapping the at least one selected content repository for data access during the transaction.

13. The computer program product of claim 12, wherein the computer usable program code for obtaining a context to a transaction, comprises computer usable program code for retrieving a context for a transaction from a business context service in a business context engine managing the transaction.

14. The computer program product of claim 12, wherein the computer usable program code for selecting the at least one content repository, comprises:
computer usable program code for matching the obtained context to at least one particular content repository in an application; and,
computer usable program code for selecting the at least one particular content repository for use when accessing data from the application for the transaction.

15. The computer program product of claim 12, wherein the computer usable program code for mapping the at least one selected content repository for data access during the transaction, comprises computer usable program code for setting the at least one selected content repository as a data source for data access logic in the application.
